(19) United States
(12) Patent Application Publication
(10) Pub. No.: US 2013/0213756 A1
(43) Pub. Date: Aug. 22, 2013

(54) FLUID BRAKE DEVICE AND VALVE TIMING CONTROL APPARATUS HAVING THE SAME

(71) Applicant: Denso Corporation, (US)

(72) Inventors: Kenichi NARA, Nagoya-city (JP); Youhei KAMIYA, Chiryu-city (JP); Seiichiro WASHINO, Nagoya-city (JP); Tooru TAKAHASHI, Chiryu-city (JP)

(73) Assignee: DENSO CORPORATION, Kariya-city (JP)

(21) Appl. No.: 13/772,797

(22) Filed: Feb. 21, 2013

(30) Foreign Application Priority Data
Feb. 21, 2012 (JP) 2012-35426

(51) Int. Cl. F16D 3/80

(52) U.S. Cl. CPC F16D 3/80
USPC 192/21.5

(57) ABSTRACT

A housing forms a fluid chamber in an inside of the housing. A magneto-rheological fluid includes a plurality of magneto-rheological particles dispersed in the magneto-rheological fluid and is filled in the fluid chamber. A partition structure partitions the fluid chamber between a radially outer region, in which the magnetic portion is exposed, and a radially inner region, which is located on a radially inner side of the radially outer region in a radial direction of a rotatable brake body, during rotation of the rotatable brake body.

### CROSS REFERENCE TO RELATED APPLICATION

This application is based on and incorporates herein by reference Japanese Patent Application No. 2012-35426 filed on Feb. 21, 2012.

### TECHNICAL FIELD

The present application relates to a fluid brake device and a valve timing control apparatus having the same.

### BACKGROUND

In a fluid brake device of a known type, a magnetic flux is passed through a magneto-rheological fluid, which is filled in a fluid chamber of a housing and is in contact with the rotatable brake body, so that a brake torque is applied to a rotatable brake body, which is in a rotating state, in conformity with a change in a viscosity of the magneto-rheological fluid. This fluid brake device can apply the brake torque to the rotatable brake body while consuming a relatively small amount of electric power. Therefore, this fluid brake device can be suitably used in, for example, a valve timing control apparatus, which adjusts a relative phase (hereinafter referred to as an engine phase) between a crankshaft and a camshaft at an internal combustion engine, and the camshaft determines the valve timing of the internal combustion engine.

For instance, JP2011-007087A teaches such a fluid brake device. Specifically, in the fluid brake device of JP2011-007087A, a magnetic portion, which is placed in an outer peripheral portion of the rotatable brake body, is in contact with the magneto-rheological fluid that includes the magneto-rheological particles dispersed therein, and a magnetic flux is passed through the magnetic portion of the rotatable brake body. In the fluid brake device of JP2011-007087A, the magneto-rheological particles are attracted to the magnetic portion, through which the magnetic flux passes, in the dispersed state of the magneto-rheological particles. In this way, the variation of the brake torque, which is applied to the magnetic portion, is limited, and the stable brake performance can be achieved.

In the fluid brake device of JP2011-007087A, the magneto-rheological fluid receives the magnetic attractive force that is directed to the magnetic portion of the rotatable brake body, through which the magnetic flux passes. Furthermore, the magneto-rheological fluid also receives a centrifugal force, which is generated through the rotation of the rotatable brake body. Therefore, the magneto-rheological particles, which are dispersed in the magneto-rheological fluid, tend to move toward a radially outer peripheral region of the fluid chamber, in which the magnetic portion of the rotatable brake body is located, thereby resulting in biasing of the magneto-rheological particles. Here, a change in the rotational speed of the rotatable brake body causes a change in the centrifugal force and thereby a change in a density of the magneto-rheological particles in the radially outer region of the fluid chamber. Thus, a variation in the brake torque may possibly occur. As a result, it is desirable to stabilize the brake performance.

### SUMMARY

The present disclosure addresses the above disadvantage. According to the present disclosure, there is provided a fluid brake device, which includes a housing, a magneto-rheological fluid, a viscosity control device, a rotatable brake body and a partition structure. The housing forms a fluid chamber in an inside of the housing. The magneto-rheological fluid includes a plurality of magneto-rheological particles dispersed in the magneto-rheological fluid and is filled in the fluid chamber. A viscosity of the magneto-rheological fluid changes in response to a magnetic flux that passes through the magneto-rheological fluid. The viscosity control device variably controls the viscosity of the magneto-rheological fluid by generating the magnetic flux that passes through the magneto-rheological fluid in the fluid chamber. The rotatable brake body includes a magnetic portion, through which the magnetic flux generated by the viscosity control device passes. A brake torque, which corresponds to the viscosity of the magneto-rheological fluid, is applied to the rotatable brake body during rotation of the rotatable brake body in a circumferential direction through contact of the magnetic portion with the magneto-rheological fluid in the fluid chamber. The partition structure partitions the fluid chamber between a radially outer region, in which the magnetic portion is exposed, and a radially inner region, which is located on a radially inner side of the radially outer region in a radial direction of the rotatable brake body, during rotation of the rotatable brake body.

There is also provided a valve timing control apparatus that adjusts valve timing of a valve, which is opened and is closed by a camshaft through transmission of a torque from a crankshaft at an internal combustion engine. The valve timing control apparatus includes the fluid brake device and a phase adjusting mechanism. The phase adjusting mechanism is connected to a rotatable shaft of the rotatable brake body at an outside of the housing and adjusts a relative phase between the crankshaft and the camshaft in response to the brake torque, which is inputted to the rotatable brake body of the fluid brake device.

### BRIEF DESCRIPTION OF THE DRAWINGS

The drawings described herein are for illustration purposes only and are not intended to limit the scope of the present disclosure in any way.

FIG. 1 is a cross-sectional view taken along line I-I in FIG. 2, showing a valve timing control apparatus having a fluid brake device according to a first embodiment of the present disclosure;

FIG. 2 is a cross-sectional view taken along line II-II in FIG. 1;

FIG. 3 is a cross-sectional view taken along line III-III in FIG. 1;

FIG. 4 is a diagram for describing characteristics of a magneto-rheological fluid of a fluid brake device according to the first embodiment;

FIG. 5 is a front view showing a partition structure of the fluid brake device of the first embodiment;

FIG. 6 is cross-sectional view, which shows a configuration of the partition structure of the first embodiment and corresponds to a corresponding view of a corresponding structure of FIG. 1;

FIG. 7 is a cross-sectional view, which schematically shows an operating state of the partition structure of the first embodiment and corresponds to the corresponding view of the corresponding structure of FIG. 1;

FIG. 8 is an enlarged partial view for describing a characteristic feature of the partition structure of the first embodiment;

FIG. 9 is a front view showing a partition structure of a fluid brake device according to a second embodiment of the present disclosure;

FIG. 10 is a schematic cross-sectional view, which shows a configuration of the partition structure of the second embodiment and corresponds to the corresponding view of the corresponding structure of FIG. 1;

FIG. 11 is a schematic cross-sectional view, which schematically shows an operating state of the partition structure of the second embodiment and corresponds to the corresponding view of the corresponding structure of FIG. 1;

FIG. 12 is a front view showing a partition structure of a fluid brake device in an initial state according to a third embodiment of the present disclosure;

FIG. 13 is a front view showing the partition structure of the fluid brake device in a displaced state according to the third embodiment of the present disclosure;

FIG. 14 is a cross-sectional view, which shows a partition structure of a fluid brake device according to a fourth embodiment of the present disclosure and is taken along line XIV-XIV in FIG. 15;

FIG. 15 is cross-sectional view, which schematically shows a configuration of the partition structure of the fluid brake device according to the fourth embodiment of the present disclosure and corresponds to the corresponding view of the corresponding structure of FIG. 1;

FIG. 16 is a cross-sectional view, which shows an operating state of the partition structure of the fluid brake device of the fourth embodiment and is taken along line XIV-XIV in FIG. 15;

FIG. 17 is a cross-sectional view, which schematically shows an operating state of the partition structure of the fourth embodiment and corresponds to the corresponding view of the corresponding structure of FIG. 1;

FIG. 18 is a cross-sectional view, which shows a partition structure of a fluid brake device in an initial state according to a fifth embodiment of the present disclosure and corresponds to a corresponding view of a corresponding structure of FIG. 14;

FIG. 19 is a cross-sectional view, which shows an operating state of the partition structure of the fluid brake device in a displaced state according to the fifth embodiment and corresponds to a corresponding view of a corresponding structure of FIG. 16;

FIG. 20 is a cross-sectional view, which shows a partition structure of a fluid brake device according to a sixth embodiment of the present disclosure and is taken along line XX-XX in FIG. 21; and

FIG. 21 is a cross-sectional view, which schematically shows a configuration of the partition structure of the sixth embodiment and corresponds to the corresponding view of the corresponding structure of FIG. 1.

### DETAILED DESCRIPTION

Various embodiments of the present disclosure will be described with reference to the accompanying drawings. In the following respective embodiments, similar components will be indicated by the same reference numerals and may not be redundantly descried for the sake of simplicity. In each of the following embodiments, if only a part of a structure is described, the remaining part is the same as that of the previously described embodiment(s). Furthermore, one or more of the components of any one of the following embodiments may be combined with any other components of another one or more of the following embodiments as long as there is no problem with respect to such a combination of the components.

### First Embodiment

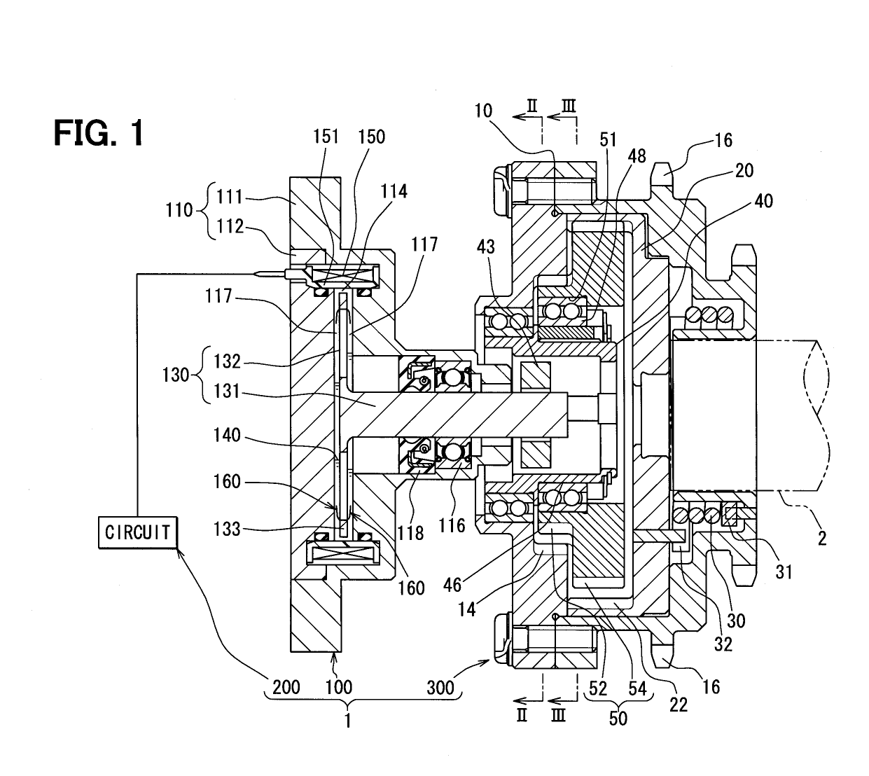

With reference to FIG. 1, a first embodiment of the present disclosure relates to a valve timing control apparatus 1, which includes a fluid brake device 100. The valve timing control apparatus 1 is installed in a vehicle (e.g., an automobile) and is placed in a transmission system, which transmits an engine torque from a crankshaft (not shown) of an internal combustion engine to a camshaft 2. The camshaft 2 opens and closes intake valves (not shown) of the internal combustion engine by transmitting the engine torque. The valve timing control apparatus 1 controls the valve timing of the respective intake valves.

As shown in FIGS. 1 to 3, the valve timing control apparatus 1 includes the fluid brake device 100, a control circuit 200 and a phase adjusting mechanism 300. The valve timing control apparatus 1 achieves desired valve timing by adjusting a relative phase (i.e., an engine phase) of the camshaft 2 relative to the crankshaft.

The fluid brake device 100 of FIG. 1 is of an electric type and includes a housing 110, a rotatable brake body 130, a magneto-rheological fluid 140 and a coil 150.

The housing 110 is a hollow housing and has a stationary member 111 and a cover member 112. The stationary member 111 is made of a magnetic material and is configured into a stepped cylindrical tubular body. The stationary member 111 is fixed to a stationary component, such as a chain case of the internal combustion engine. The cover member 112 is made of a magnetic material and is configured into a circular dish body. The cover member 112 is placed on an axial side of the stationary member 111, which is opposite from the phase adjusting mechanism 300. The cover member 112 is fluid-tightly and securely fitted to the stationary member 111. A space, which is defined between the cover member 112 and the stationary member 111, serves as a fluid chamber 114 of the housing 110.

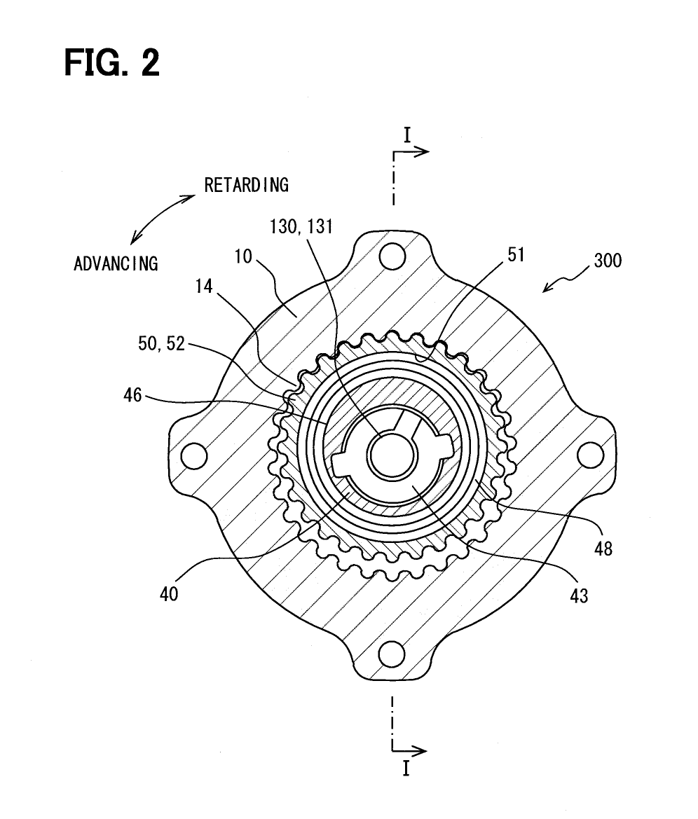

The rotatable brake body 130 has a rotatable shaft 131 and a magnetic rotor 132. The rotatable shaft 131 is made of a metal material and is configured into a cylindrical body. The rotatable shaft 131 is coaxial with the stationary member 111 and the cover member 112 of the housing 110. The rotatable shaft 131 extends through the stationary member 111, which is located on the phase adjusting mechanism 300 side in the housing 110, so that the rotatable shaft 131 is connected to the phase adjusting mechanism 300. An axial intermediate portion of the rotatable shaft 131 is rotatably supported by a bearing 116, which is provided in the stationary member 111. Furthermore, the axial intermediate portion of the rotatable shaft 131 is sealed from the stationary member 111 by a seal member 118, which is axially placed on the fluid chamber 114 side of the bearing 116. The rotatable brake body 130 is rotated in a predetermined direction (a counterclockwise direction in FIGS. 2 and 3) when the engine torque, which is outputted from the crankshaft in the driving state of the internal combustion engine, is transmitted to the phase adjusting mechanism 300.

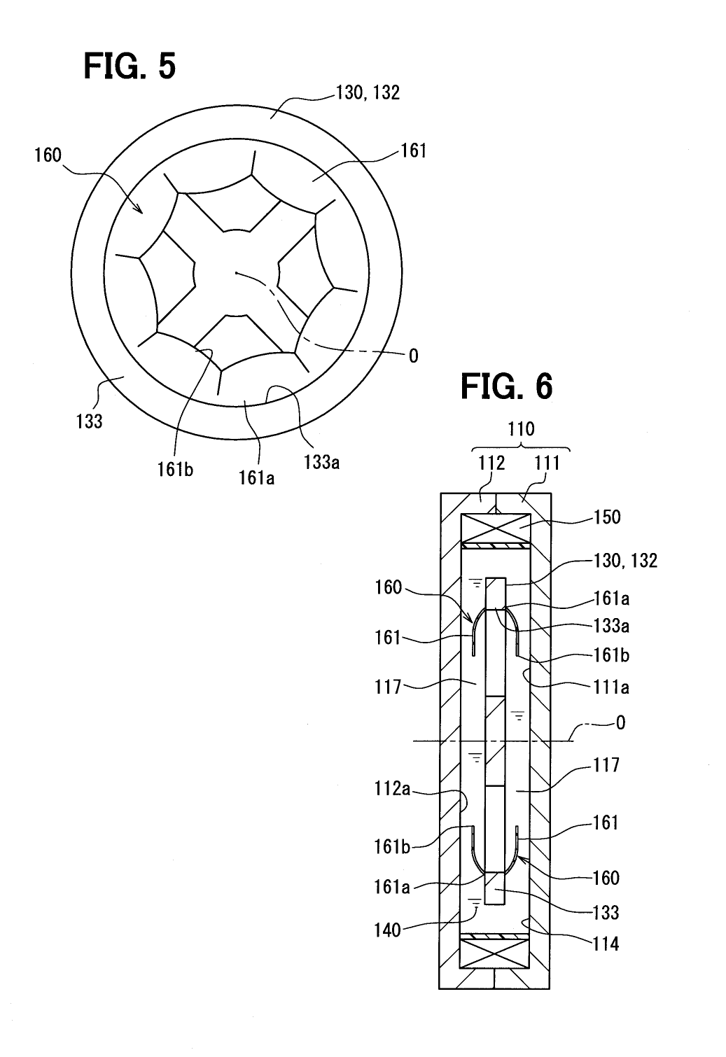

With reference to FIG. 1, the magnetic rotor 132 is made of a magnetic material and is configured into a circular ring plate (ring disk) body. The magnetic rotor 132 is received in the fluid chamber 114 of the housing 110 such that the magnetic rotor 132 radially outwardly projects from an axial end portion of the rotatable shaft 131 on the axial side, which is opposite from the phase adjusting mechanism 300. The magnetic rotor 132 forms two circular ring gaps 117 on one axial side and the other axial side, respectively, of the magnetic rotor 132 at an axial location between the stationary member 111 and the cover member 112 of the housing 110. These circular ring gaps 117 form the part of the fluid chamber 114. The magnetic rotor 132 has a magnetic portion 133, which is configured into a circular ring body that circumferentially extends along an entire outer peripheral portion of the magnetic rotor 132 to conduct the magnetic flux generated from the coil 150. In the magnetic rotor 132 of the present embodiment, the magnetic portion 133 is radially connected to the rotatable shaft 131 at four circumferential locations (see FIG. 5). However, the number of the connections between the magnetic portion 133 and the rotatable shaft 131 is not limited to four and may be changed to any other appropriate number, such as three.

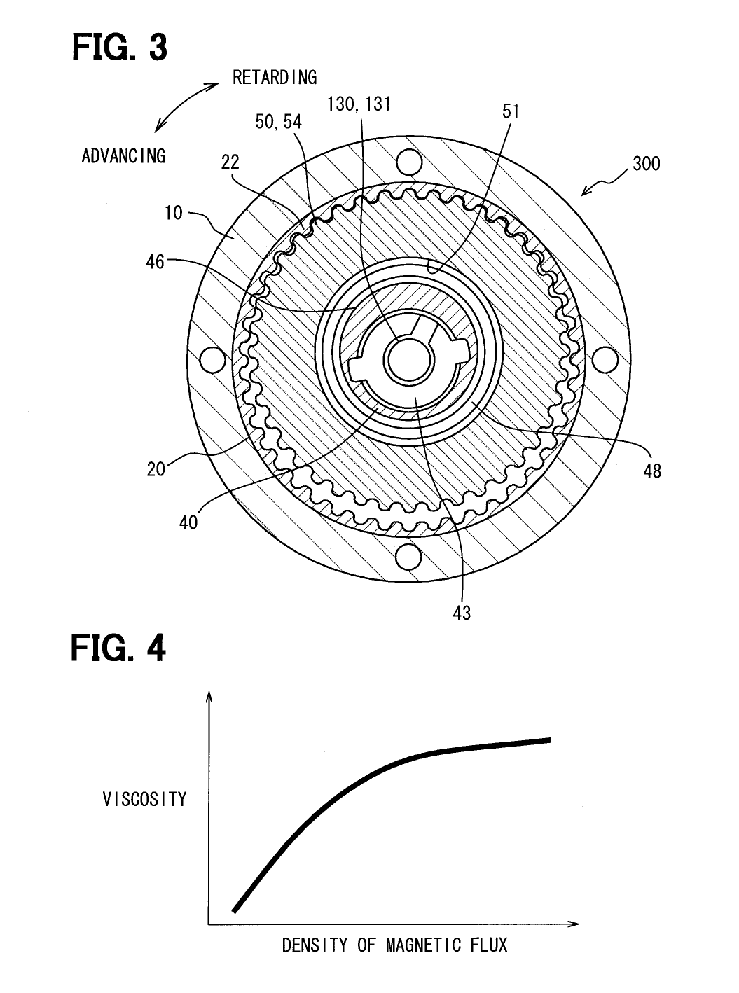

The magneto-rheological fluid 140 is filled in the fluid chamber 114 and is sealed in the inside of the housing 110. The magneto-rheological fluid 140 is a functional fluid, which includes a plurality of magneto-rheological particles 140a suspended in a non-magnetic base fluid. The base fluid of the magneto-rheological fluid 140 is a non-magnetic material in a fluid form, such as an oil. The base fluid is preferably an oil, which is the same as a lubricant oil of the internal combustion engine. In the present embodiment, a powder of a magnetic material, such as carbonyl iron power, is used as the magneto-rheological particles 140a of the magneto-rheological fluid 140. As indicated in FIG. 4, an apparent viscosity of the magneto-rheological fluid 140 is increased when a density of a magnetic flux, which passes through the magneto-rheological fluid 140, is increased. Therefore, a yield stress of the magneto-rheological fluid 140 is increased in proportional to the apparent viscosity of the magneto-rheological fluid 140. In the magneto-rheological fluid 140 of the present embodiment, a dispersing agent, which disperses the magneto-rheological particles 140a, is not added in the base fluid. Therefore, a torque loss, which results from an increase in the viscosity of the base fluid under the extreme low temperature, is limited. However, the dispersing agent may be added to the base fluid to disperse the magneto-rheological particles 140a, if desired.

With reference to FIG. 1, the coil 150 is formed by winding a metal wire around a bobbin 151 made of a resin material. The coil 150 is placed on a radially outer side of the magnetic rotor 132 in a coaxial manner. The coil 150 is held by the housing 110 such that the coil 150 is clamped between the stationary member 111 and the cover member 112. In this installed state of the coil 150, when the coil 150 is energized, the magnetic flux flows through the cover member 112, the one gap 117, the magnetic portion 133, the other gap 117 and the stationary member 111 in this order. Therefore, when the magnetic flux is generated through the energization of the coil 150 in the driving state of the internal combustion engine, the magneto-rheological particles 140a of the magneto-rheological fluid 140, which have the increased viscosity, are attracted to the magnetic portion 133 and the housing 110, which are in contact with the magneto-rheological fluid 140 (see FIG. 8). Therefore, a brake force is exerted on the rotatable brake body 130 in an opposite circumferential direction (the clockwise direction in FIGS. 2 and 3), which is opposite from the rotational direction of the magnetic rotor 132, due to the viscous drag exerted thereto from the magneto-rheological fluid 140.

The control circuit 200 of FIG. 1 has a microcomputer as its main component and is placed at an outside of the fluid brake device 100. The control circuit 200 is electrically connected to the coil 150 of the fluid brake device 100. In the driving state of the internal combustion engine, the control circuit 200 controls the electric current supplied to the coil 150 to variably control the viscosity of the magneto-rheological fluid 140. As a result of this variable control operation, the brake torque, which is applied to the rotatable brake body 130, is increase or decreased depending on the amount of electric current supplied to the coil 150. In this way, the engine phase is adjusted by the phase adjusting mechanism 300. As discussed above, in the present embodiment, the control circuit 200 and the coil 150 cooperate together to form a viscosity control device (viscosity control means).

As shown in FIGS. 1 to 3, the phase adjusting mechanism 300 includes a driving-side rotatable body 10, a driven-side rotatable body 20, an assist member 30, a planetary carrier 40 and a planetary gear 50.

With reference to FIGS. 1 and 2, the driving-side rotatable body 10 is made of a metal material and is configured into a cylindrical tubular body. A peripheral wall portion of the driving-side rotatable body 10 forms driving-side internal gear teeth 14 and sprocket teeth 16. The driving-side internal gear teeth 14 form an addendum circle, which has a diameter that is smaller than a diameter of a dedendum circle of the driving-side internal gear teeth 14. The sprocket teeth 16 radially outwardly project from the peripheral wall of the driving-side rotatable body 10. The driving-side rotatable body 10 is connected to the crankshaft through a timing chain (not shown), which is wound around the sprocket teeth 16 and the teeth of the crankshaft. In the driving state of the internal combustion engine of the present embodiment, the engine torque, which is outputted from the crankshaft, is conducted to the driving-side rotatable body 10, so that the driving-side rotatable body 10 is rotated in the one direction (the counterclockwise direction in FIGS. 2 and 3) synchronously with the rotation of the crankshaft.

With reference to FIGS. 1 and 3, the driven-side rotatable body 20 is made of a metal material and is configured into a cup shape body. The driven-side rotatable body 20 is placed on a radially inner side of the driving-side rotatable body 10 in a coaxial manner. A peripheral wall portion of the driven-side rotatable body 20 forms driven-side internal gear teeth 22, which form an addendum circle that has a diameter smaller than a diameter of a dedendum circle of the driven-side internal gear teeth 22. A bottom wall portion of the driven-side rotatable body 20 is coaxially connected to the camshaft 2. In the driving state of the internal combustion engine, the driven-side rotatable body 20 is rotated in the one direction (the counterclockwise direction in FIGS. 2 and 3) synchronously with the rotation of the camshaft 2 and is rotatable relative to the driving-side rotatable body 10.

As shown in FIG. 1, the assist member 30, which is a torsion coil spring made of a metal material, is placed on a radially inner side of the driving-side rotatable body 10 in a coaxial manner. The assist member 30 urges the driven-side rotatable body 20 toward the retarding side relative to the driving-side rotatable body 10 upon torsional deformation of the assist member 30 between two end portions 31, 32 of the assist member 30, which are engaged with the driving-side rotatable body 10 and the driven-side rotatable body 20, respectively.

With reference to FIGS. 1 to 3, the planetary carrier 40 is made of a metal material and is configured into a cylindrical tubular body. Furthermore, the planetary carrier 40 is coaxially connected to the rotatable shaft 131 of the rotatable brake body 130 through a joint 43. In the driving state of the internal combustion engine, the planetary carrier 40 is rotated together with the rotatable brake body 130 in the predetermined direction (the counterclockwise direction in FIGS. 2 and 3) and is rotatable relative to the driving-side rotatable body 10. A peripheral wall portion of the planetary carrier 40 forms a bearing 46. The bearing 46, which forms a cylindrical surface and is eccentric to the driving-side rotatable body 10 and the driven-side rotatable body 20, is coaxially fitted into a center hole 51 of the planetary gear 50. The planetary gear 50 is rotatably supported by the bearing 46 and is capable of making planetary motion.

The planetary gear 50 is made of a metal material and is configured into a stepped cylindrical tubular body. A peripheral wall portion of the planetary gear 50 forms driving-side external gear teeth 52 and driven-side external gear teeth 54. The driving-side external gear teeth 52 form an addendum circle that has a diameter smaller than a diameter of a dedendum circle of the driving-side external gear teeth 52, and the driven-side external gear teeth 54 form an addendum circle that has a diameter smaller than a diameter of a dedendum circle of the driven-side external gear teeth 54. The driving-side external gear teeth 52 are placed radially inward of the driving-side internal gear teeth 14 and are meshed with the driving-side internal gear teeth 14. The driven-side external gear teeth 54 are arranged on a radially inner side of the driven-side internal gear teeth 22 and are meshed with the driven-side internal gear teeth 22.

With the above construction, the phase adjusting mechanism 300 adjusts the engine phase in response to the brake torque, which is inputted to the rotatable brake body 130, and the assist torque of the assist member 30, which is applied to the rotatable brake body 130 in the direction that is opposite from the direction of the application of the brake torque. Specifically, when the rotatable brake body 130 is rotated at the same rotational speed as that of the driving-side rotatable body 10 by maintaining the brake torque, the planetary carrier 40 is rotated relative to the driving-side rotatable body 10. Therefore, the planetary gear 50 does not make the planetary motion and is rotated together with the driving-side rotatable body 10 and the driven-side rotatable body 20, so that the engine phase is maintained. In contrast, when the rotatable brake body 130 is rotated against the assist torque at a lower speed, which is lower than the rotational speed of the driving-side rotatable body 10, in response to an increase in the brake torque, the planetary carrier 40 is rotated relative to the driving-side rotatable body 10 toward the retarding side. Therefore, the planetary gear 50 makes the planetary motion, so that the driven-side rotatable body 20 is rotated toward the advancing side relative to the driving-side rotatable body 10. Thus, the engine phase is advanced. In contrast, when the rotatable brake body 130 receives the assist torque and is rotated at a higher speed, which is higher than the rotational speed of the driving-side rotatable body 10, in response to, for example, a decrease in the brake torque, the planetary carrier 40 is rotated toward the advancing side relative to the driving-side rotatable body 10. Therefore, the planetary gear 50 makes the planetary motion, so that the driven-side rotatable body 20 is rotated toward the retarding side relative to the driving-side rotatable body 10. Thus, the engine phase is retarded.

Two partition structures 160 of the fluid brake device 100 shown in FIG. 1 will now be described. In the following description, the axial direction, the radial direction and the circumferential direction of the magnetic rotor 132 will be simply referred to as the axial direction, the radial direction and the circumferential direction, respectively, for the sake of simplicity.

As shown in FIGS. 5 and 6, each partition structure 160 includes a partition member (annular partition member) 161. The partition member 161 is made of an elastic material (e.g., rubber or elastic resin) and is configured into an annular elastic thin film (annular flexible think film). The partition member 161 of the partition structure 160 is coaxially placed in a corresponding gap 117, which is formed between the stationary member 111 and the magnetic rotor 132. The partition member 161 of the other partition structure 160 is coaxially placed in a corresponding gap 117, which is formed between the cover member 112 and the magnetic rotor 132.

Here, a radially outer portion 161a of each partition member 161, which is configured into a circular form, is installed to an inner peripheral part 133a of the magnetic portion 133 along an entire circumferential extent of the inner peripheral part 133a, so that the partition member 161 is held by the magnetic rotor 132 to rotate integrally with the magnetic rotor 132. Furthermore, a radially inner portion 161b of the partition member 161, which is configured into a wavy form, projects into the corresponding gap 117.

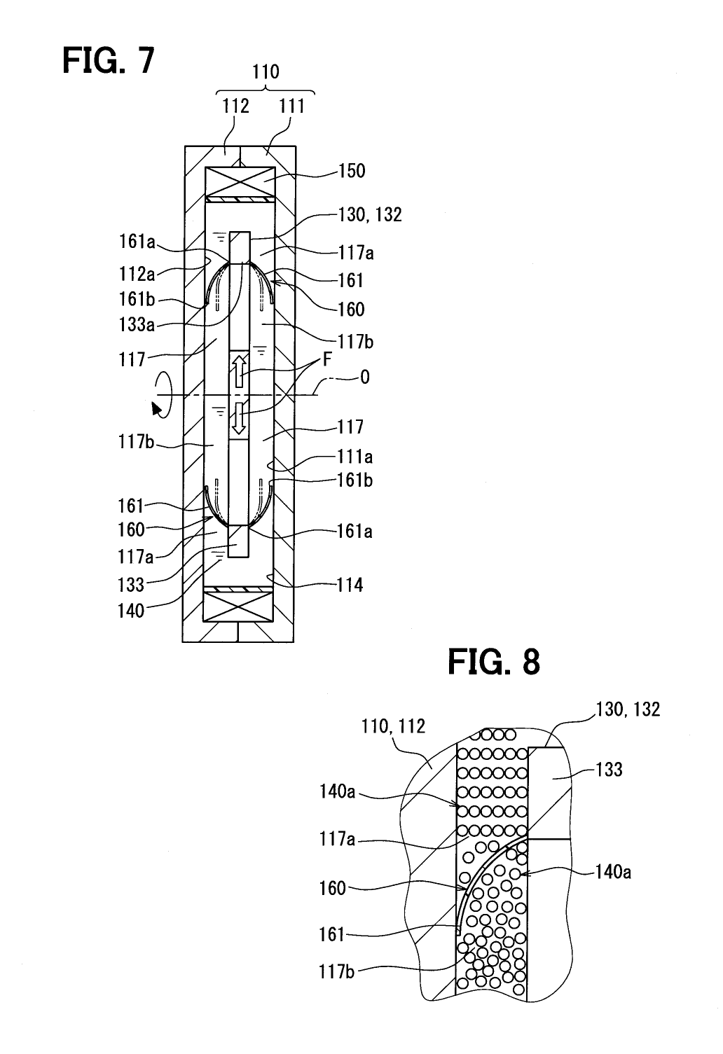

In a stopped state of the rotatable brake body 130, which is stopped, i.e., is not rotated due to stop of the internal combustion engine, a centrifugal force F (see FIG. 7) is not applied to each partition member 161. Therefore, each partition member 161 is elastically contracted. Thus, each partition member 161 is held in an initial state of FIGS. 5 and 6 (also see a dot-dot dash line in FIG. 7), in which the radially inner portion 161b of each partition member 161 is radially inwardly displaced toward the rotational center O in the corresponding gap 117. In contrast, in the rotating state of the rotatable brake body 130, which is rotated due to the rotation of the internal combustion engine, the centrifugal force F is applied to each partition member 161. Therefore, each partition member 161 is elastically expanded. Thus, each partition member 161 is held in a displaced state of FIG. 7 (see a solid line), in which the radially inner portion 161b of each partition member 161 is displaced in the application direction of the centrifugal force F (i.e., in the radially outward direction) in the corresponding gap 117. In other words, the radially inner portion 161 of the partition member 161 is displaced in the radially outward direction upon elastic expansion of the partition member 161 when the partition member 161 receives the centrifugal force of the rotatable brake body 130. At this time, the radially inner portion 161b of the partition member 161 approaches to a location, which is slightly spaced from an inner surface 111a of the stationary member 111 or an inner surface 112a of the cover member 112, or the radially inner portion 161b of the partition member 161 contacts the inner surface 111a of the stationary member 111 or the inner surface 112a of the cover member 112. In this way, each partition member 161 partitions the corresponding gap 117 into a radially outer region 117a and a radially inner region 117b. In the present embodiment, the radially inner region 117b is partitioned from the radially outer region 117a, in which the magnetic portion 133 of the magnetic rotor 132 is exposed, by the corresponding partition member 161.

Advantages of the first embodiment will now be described.

In the fluid brake device 100 of the first embodiment, the partition member 161 of each of the two partition structures 160 partitions the corresponding gap 117 of the fluid chamber 114 into the radially outer region 117a and the radially inner region 117b in the rotating state of the rotatable brake body 130. Therefore, even in the case where the centrifugal force F of the rotatable brake body 130 is generated, movement of the magneto-rheological particles 140a of the magneto-rheological fluid 140 in the radially inner region 117b to the radially outer region 117a is limited by the corresponding partition member 161. Therefore, in the radially outer region 117a, in which the magnetic portion 133 (i.e., the portion through which the magnetic flux flows) of the rotatable brake body 130 is exposed, a change in the density of the magneto-rheological particles 140a in the magneto-rheological fluid 140 is limited, and thereby the variation in the brake torque, which is applied to the magnetic portion 133, is limited. Therefore, the stable brake performance can be achieved.

Furthermore, at each axial location between the housing 110 and the rotatable brake body 130, the corresponding partition member 161 is placed such that the partition member 161 is rotated integrally with the rotatable brake body 130 in the state where the radially outer region 117a and the radially inner region 117b are partitioned from each other by the partition member 161. Therefore, this partitioned state can be reliably maintained in the rotating state of the rotatable brake body 130. In this way, the movement of the magneto-rheological particles 140a from the radially inner region 117b to the radially outer region 117a is limited, and thereby the variation in the brake torque, which is applied to the magnetic portion 133, can be limited. Thus, the stability of the braking performance can be improved.

Furthermore, each partition member 161, which is held by the rotatable brake body 130 through the radially outer portion 161a, is constructed such that the radially inner portion 161b is displaceable in the application direction of the centrifugal force F (in the radially outward direction) upon application of the centrifugal force F. Thereby, in the axial direction, the radially inner portion 161b of each partition member 161 approaches or contacts the corresponding one of the stationary member 111 and the cover member 112 of the housing 110. As a result, it is possible to reliably maintain the partitioned state, in which the radially inner region 111b and the radially outer region 117a are partitioned from each other by the corresponding partition member 161. As a result, the movement of the magneto-rheological particles 140a from the radially inner region 117b to the radially outer region 117a is limited, and thereby the variation in the brake torque applied to the magnetic portion 133 can be limited. Furthermore, in the stop state of the rotatable brake body 130, the centrifugal force F is lost, and thereby the radially inner portion 161b of each partition member 161 is returned to the initial state, which is the state before the occurrence of the displacement of the radially inner portion 161b. Thus, the radially inner portion 161b is largely displaced from the corresponding one of the stationary member 111 and the cover member 112, and thereby the movement of the magneto-rheological particles 140a between the radially inner region 117b and the radially outer region 117a is enabled. In this way, it is possible to limit the continuous attraction of the magneto-rheological particles 140a to the magnetic portion 133, which results in the deterioration of the magneto-rheological fluid 140 and thereby the variation in the brake torque. Thus, the above limiting effect can enable the improvement of the stability of the brake performance.

Furthermore, each partition member 161, which is held by the rotatable brake body 130 through the radially outer portion 161a along the entire circumferential extent of the radially outer portion 161a, can elastically expand upon application of the eccentric force F to enable the displacement of the radially inner portion 161b in the application direction of the centrifugal force F (in the radially outward direction) relative to the radially outer portion 161a. Thereby, the stabilization of the brake performance and the simplification of the structure can be both achieved.

Furthermore, in the first embodiment, in the driving state of the internal combustion engine, in which the rotatable brake body 130 is rotated together with the crankshaft and the camshaft 2, the variation of the brake torque is limited by each partition structure 160, and thereby the stable braking performance can be achieved. Thus, the engine phase, which corresponds to the brake torque inputted from the fluid brake device to the phase adjusting mechanism, can be accurately adjusted.

### Second Embodiment

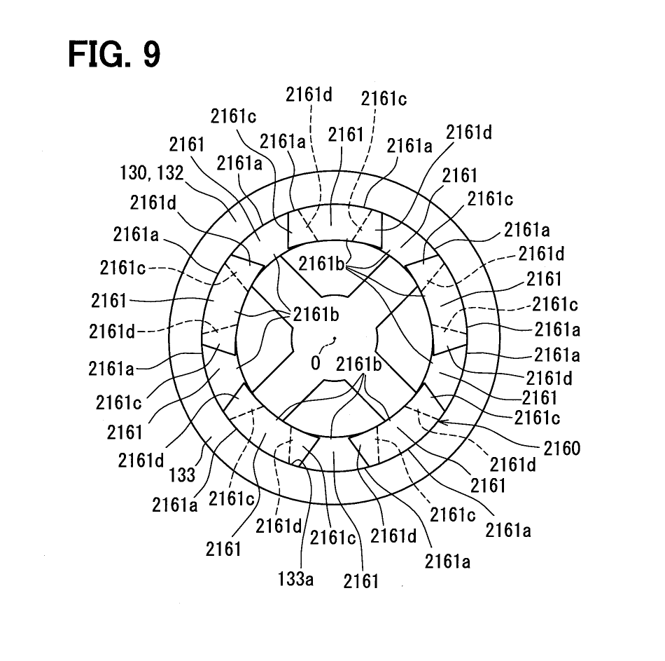

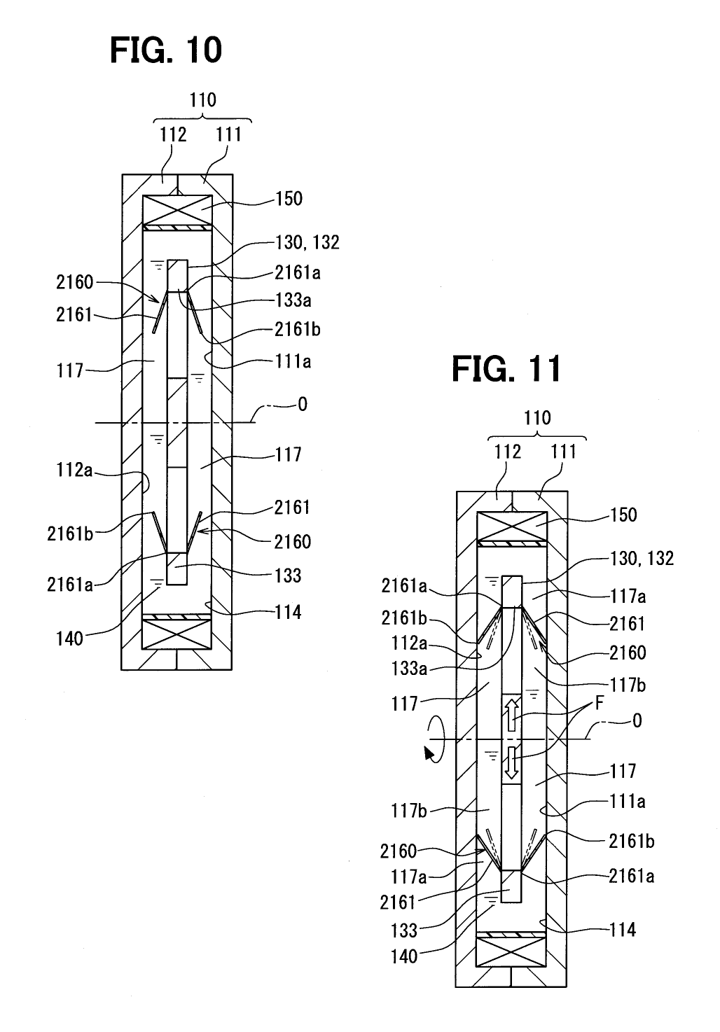

With reference to FIGS. 9 and 10, a second embodiment of the present disclosure, which is a modification of the first embodiment, will be described. Each of the partition structures 2160 of the second embodiment includes a plurality of partition members 2161, each of which is made of an elastic material and is configured into an arcuate band (arcuate form) of a flexible thin film. Each partition member 2161, which is provided in a corresponding one of the two partition structures 2160, is placed in a corresponding gap 117 between the stationary member 111 and the magnetic rotor 132 in such a manner that circumferentially adjacent end portions 2161c, 2161d of each circumferentially adjacent two partition members 2161 circumferentially overlap with each other. Each partition member 2161, which is provided in the other one of the two partition structures 2160, is placed in a corresponding gap 117 between the cover member 112 and the magnetic rotor 132 in such a manner that circumferentially adjacent end portions 2161c, 2161d of each circumferentially adjacent two partition members 2161 circumferentially overlap with each other.

Here, in each partition member 2161, a radially outer portion 2161a, which is arcuately configured, is installed to a corresponding area of the inner peripheral part 133a of the magnetic portion 133, so that the partition members 2161 are held by the magnetic rotor 132 to rotate integrally with the magnetic rotor 132. Furthermore, in each partition member 161, a radially inner portion 2161b, which is arcuately configured, projects into the corresponding gap 117.

In the stop state of the rotatable brake body 130, each partition member 2161, to which the centrifugal force F (see FIG. 11) is not applied, is returned to the initial state of FIGS. 9 and 10 in the corresponding gap 117 through the swing motion of the radially inner portion 2161b about the radially outer portion 2161a. In contrast, in the rotating state of the rotatable brake body 130, each partition member 2161, to which the centrifugal force F is applied, is placed in the displaced state of FIG. 11 in the corresponding gap 117 through the swing motion of the radially inner portion 2161b in the application direction of the centrifugal force F (in the radially outward direction) about the radially outer portion 2161a. At this time, the radially inner portions 2161b of each circumferentially adjacent two partition members 2161, which circumferentially overlap with each other and are swung in the application direction of the centrifugal force F (in the radially outward direction), approach or contact the inner surface 111a of the stationary member 111 or the inner surface 112a of the cover member 112. In this way, each gap 117 is partitioned between the radially outer region 117a and the radially inner region 117b.

In the second embodiment, the partition members 2161 of each partition structure 2160 are arranged between the rotatable brake body 130 and the corresponding one of the stationary member 111 and the cover member 112 and are rotatable integrally with the rotatable brake body 130. Furthermore, in the rotating state of the rotatable brake body 130, the radially inner portions 2161b of the partition members 2161 are displaced in the application direction of the centrifugal force F. In this way, each gap 117 is partitioned between the radially outer region 117a and the radially inner region 117b, and the stable brake performance is achieved. Furthermore, the partitioned state is reliably maintained to improve the stability of the brake performance.

Furthermore, in each corresponding gap 117, the circumferentially adjacent end portions of each circumferentially adjacent two partition members 2161 are circumferentially overlapped with each other, and the radially inner portion 2161b of each partition member 2161, to which the centrifugal force F is applied, can be easily swung in the application direction of the centrifugal force F (in the radially outward direction) about the radially outer portion 2161a of the partition member 2161 held by the rotatable brake body 130. In this way, in the rotating sate of the rotatable brake body 130, the radially inner portion 2161b of each partition member 2161 can easily and rapidly approach or contact the housing 110 to partition between the radially inner region 117b and the radially outer region 117a. In addition, each partition member 2161, which is held by the corresponding circumferential area of the rotatable brake body 130, will have a smaller amount of deformation at the time of swing of the partition member 2161, and thereby the high durability can be maintained. The limiting of the movement of the magneto-rheological particles 140a, which is required to limit the variation in the brake torque, can be achieved at the appropriate timing and through the relatively long period of time to improve the stability of the brake performance.

### Third Embodiment

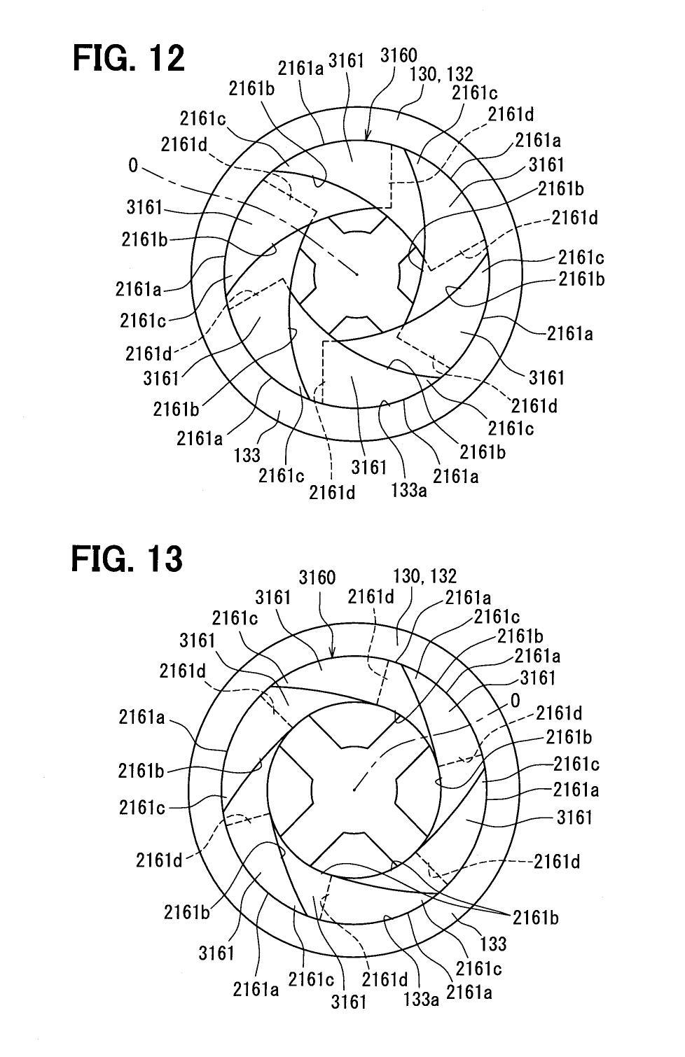

A third embodiment of the present disclosure, which is a modification of the second embodiment, will be described with reference to FIG. 12. The third embodiment is similar to the second embodiment except that each of a plurality of partition members 3161 of each of two partition structures 3160 is configured into a triangular form, and one side of each triangular partition member 3161 forms a radially inner portion 2161b that is arcuately configured. Thereby, in the stop state of the rotatable brake body 130, the radially inner portion 2161b of each partition member 3161, to which the centrifugal force F is not applied, is swung about the radially outer portion 2161a toward the rotational axis 0, so that the initial state of FIG. 12 is achieved. In contrast, in the rotating state of the rotatable brake body 130, each partition member 3161, to which the centrifugal force F is applied, is placed in the displaced state of FIG. 13 in the corresponding gap 117 through the swing motion of the radially inner portion 2161b in the application direction of the centrifugal force F (in the radially outward direction) about the radially outer portion 2161a.

Therefore, in the third embodiment, the advantages, which are similar to those of the second embodiment, can be achieved. Furthermore, according to the third embodiment, the radially inner portion 2161b of each partition member 3161, which is configured into the triangular form, can be easily deformed to conform with the inner surface 111a of the stationary member 111 or the inner surface 112a of the cover member 112 of the housing 110 through the swing motion of the radially inner portion 2161b. As a result, a degree of blocking between the radially inner region 117b and the radially outer region 117a through the partitioning therebetween with the partition members 3161 can be improved. Thus, the movement of the magneto-rheological particles 140a from the radially inner region 117b to the radially outer region 117a can be reliably limited to improve the stability of the brake performance.

### Fourth Embodiment

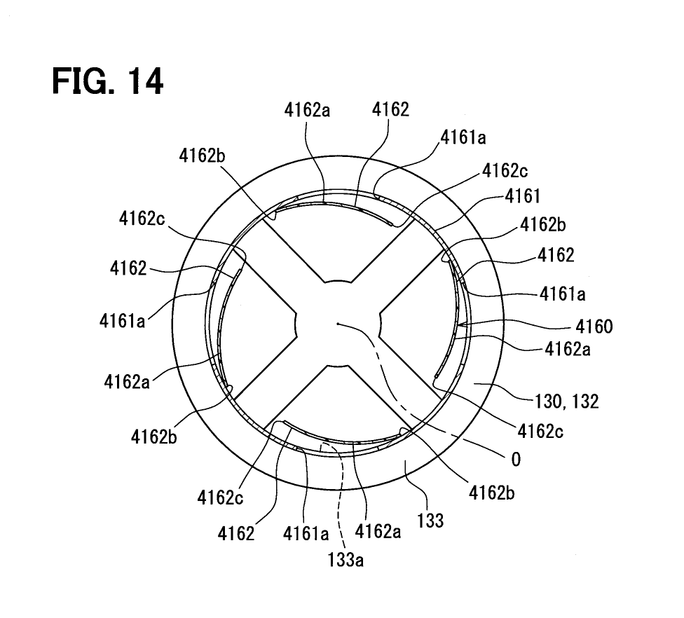

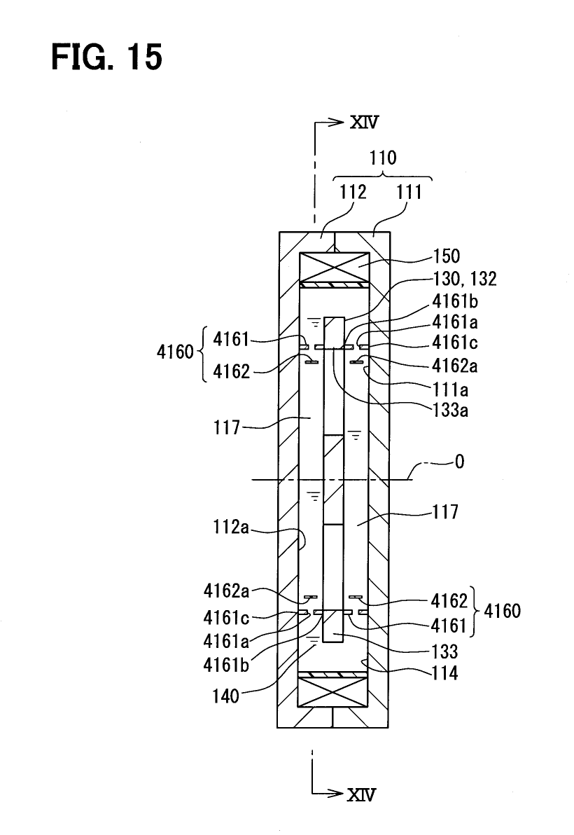

A fourth embodiment of the present disclosure, which is a modification of the first embodiment, will be described with reference to FIGS. 14 and 15. Each of two partition structures 4160 of the fourth embodiment includes a single primary partition member 4161, which is made of a metal material or a resin material and is configured into a cylindrical tubular body that has a rigid thin wall. The primary partition member 4161 of one of the partition structures 4160 is placed in the gap 117 between the stationary member 111 and the magnetic rotor 132 and has a plurality of through windows 4161a, which are arranged one after another in the circumferential direction. Each through window 4161a is configured into a rectangular form and radially extends through the primary partition member 4161. The primary partition member 4161 of the other one of the partition structures 4160 is placed in the gap 117 between the cover member 112 and the magnetic rotor 132 and has a plurality of through windows 4161a, which are arranged one after another in the circumferential direction and are similar to the above described through windows 4161a.

Each of the partition structures 4160 of the fourth embodiment further includes a plurality of secondary partition members 4162, each of which is made of an elastic material and is configured into a rectangular form of a flexible film. The secondary partition members 4162 of one of the partition structures 4160 are placed in the gap 117 between the stationary member 111 and the magnetic rotor 132 such that a circumferentially intermediate portion 4162a of each secondary partition member 4162, which is circumferentially placed between two circumferential end portions 4162b, 4162c of the secondary partition member 4162, is radially opposed to a corresponding one of the through windows 4161a of the corresponding primary partition member 4161. The secondary partition members 4162 of the other one of the partition structures 4160 are placed in the gap 117 between the cover member 112 and the magnetic rotor 132 such that the circumferentially intermediate portion 4162a of each secondary partition member 4162 is radially opposed to a corresponding one of the through windows 4161a of the corresponding primary partition member 4161.

Here, one axial end portion 4161b of each primary partition member 4161 is installed to the inner peripheral part 133a of the magnetic portion 133 along the entire circumferential extent of the inner peripheral part 133a, so that the primary partition member 4161 is held by the magnetic rotor 132 to rotate integrally with the magnetic rotor 132. Furthermore, the other axial end portion 4161c of each primary partition member 4151 is positioned at a corresponding location, which is slightly spaced from or contacts the inner surface 111a of the stationary member 111 or the inner surface 112a of the cover member 112. Thereby, the radially outer region 117a and the radially inner region 117b are partitioned from each other at the location around each through window 4161a.

Furthermore, the one circumferential end portion 4162b of each secondary partition member 4162 is installed to a corresponding location of the primary partition member 4161, which is circumferentially displaced from a corresponding one of the through windows 4161a, so that the secondary partition members 4162 are held by the primary partition member 4161 to rotate integrally with the primary partition member 4161. Therefore, each secondary partition member 4162 is held by the magnetic rotor 132 through the primary partition member 4161 to rotate integrally with the magnetic rotor 132.

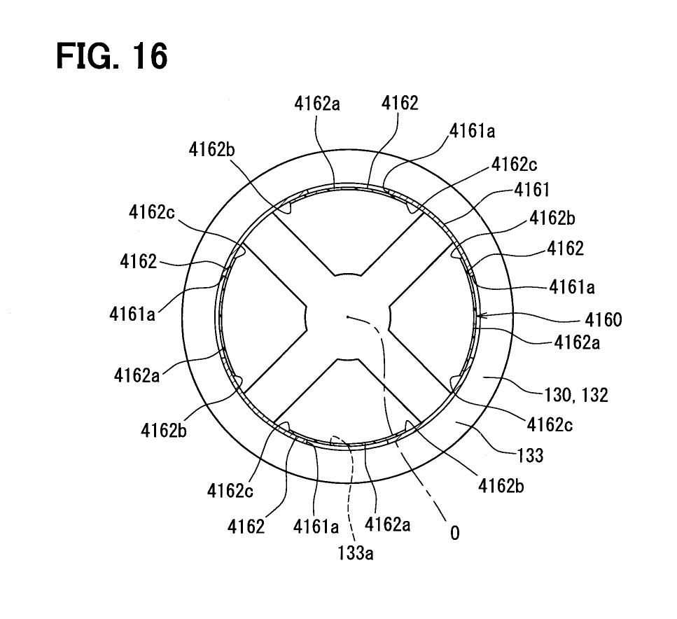

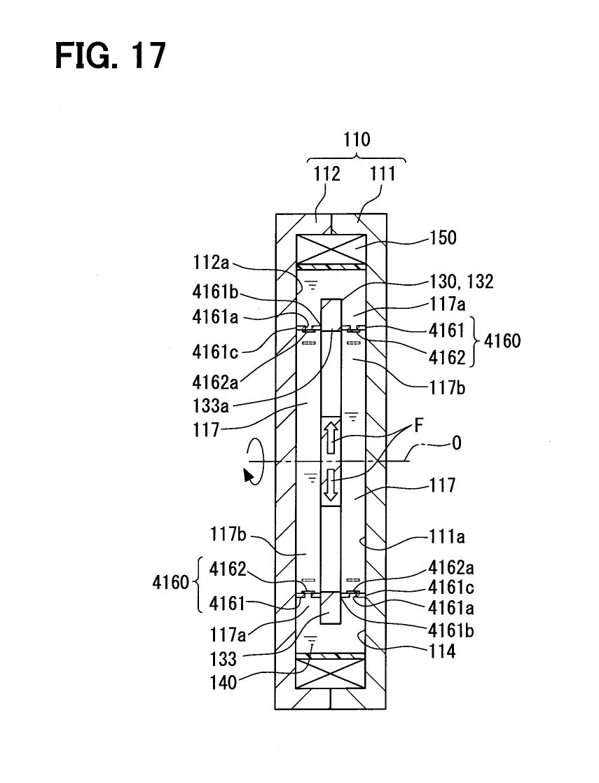

In the stop state of the rotatable brake body 130, each secondary partition member 4162, to which the centrifugal force F (see FIG. 17) is not applied, is placed in the initial state in the corresponding gap 117 shown in FIGS. 14 and 15 through the swing motion of the other circumferential end portion 4162c of the secondary partition member 4162 about the one circumferential end portion 4162b toward the rotational center O. In contrast, in the rotating state of the rotatable brake body 130, each secondary partition member 4162, to which the centrifugal force F is applied, is placed in the displaced state of FIGS. 16 and 17 in the corresponding gap 117 through the swing motion of the other circumferential end portion 4162c of the secondary partition member 4162 in the application direction of the centrifugal force F (in the radially outward direction) about the one circumferential end portion 4162b. At this time, the circumferentially intermediate portion 4162a of each secondary partition member 4162 covers the corresponding through window 4161a, which is radially opposed to the circumferentially intermediate portion 4162a, so that the other circumferential end portion 4162c and the two axial end portions of the secondary partition member 4162 contact the primary partition member 4161 around the through window 4161a. As a result, even in each corresponding location, at which the corresponding through window 4161a is formed, the radially outer region 117a and the radially inner region 117b are partitioned by the corresponding secondary partition member 4162.

According to the fourth embodiment discussed above, the primary partition member 4161 and the secondary partition members 4162 of each partition structure 4160 cooperate with each other in the rotating state of the rotatable brake body 130 to partition between the radially outer region 117a and the radially inner region 117b from each other in the corresponding gap 117 of the fluid chamber 114. Therefore, according to the principle, which is similar to that of the first embodiment, the stable brake performance can be achieved.

Furthermore, the primary partition member 4161 and the secondary partition members 4162 of each partition structure 4160 are axially placed between the housing 110 (more specifically the corresponding one of the stationary member 111 and the cover member 112) and the rotatable brake body 130 such that the primary partition member 4161 and the secondary partition members 4162 are rotated integrally with the rotatable brake body 130 in the state where the radially inner region 117b and the radially outer region 117a are partitioned from each other in the corresponding gap 117. Therefore, according to the principle, which is similar to that of the first embodiment, the stability of the brake performance can be improved.

Furthermore, although the primary partition member 4161 of each partition structure 4160 partitions between the radially inner region 117b and the radially outer region 117a, the through windows 4161a are formed to radially extend through the primary partition member 4161. Therefore, the communication between the radially inner region 117b and the radially outer region 117a is possible through these through windows 4161a. Thus, while the one circumferential end portion 4162b of each secondary partition member 4162 is held by the primary partition member 4161, the other circumferential end portion 4162c of the secondary partition member 4162 is swung about the one circumferential end portion 4162b in the application direction of the centrifugal force F (in the radially outward direction) upon the application of the centrifugal force F from the rotating magnetic rotor 132 to the other circumferential end portion 4162c. Thereby, each through window 4161a is covered, i.e., closed by the corresponding secondary partition member 4162. Therefore, the communication between the radially inner region 117b and the radially outer region 117a through each through window 4161a is limited. Thus, the reliable partitioned state, in which the radially inner region 117b and the radially outer region 117a are partitioned from each other, can be maintained through the cooperation of the primary partition member 4161 and the secondary partition members 4162. As a result, the movement of the magneto-rheological particles 140a from the radially inner region 117b to the radially outer region 117a is limited, and thereby the variation in the brake torque applied to the magnetic portion 133 can be limited. Furthermore, in the stop state of the rotatable brake body 130, the centrifugal force F is lost, and thereby the other circumferential end portion 4162c of each secondary partition member 4162 is returned to the initial state to open the corresponding through window 4161a. Therefore, the movement of the magneto-rheological particles 140a between the radially inner region 117b and the radially outer region 117a is enabled. In this way, it is possible to limit the continuous attraction of the same magneto-rheological particles 140a to the magnetic portion 133, which results in the deterioration of the magneto-rheological fluid 140 and thereby the variation in the brake torque. Here, the setting freedom of the size of each through window 4161a and the size of each secondary partition member 4162 is relatively high. Therefore, through the setting of the size of each through window 4161a and the size of each secondary partition member 4162, the amount of movement of the magneto-rheological particles 140a, which is required to limit the variation in the brake torque, can be appropriately adjusted. Thus, the above limiting effect can enable the improvement of the stability of the brake performance.

### Fifth Embodiment

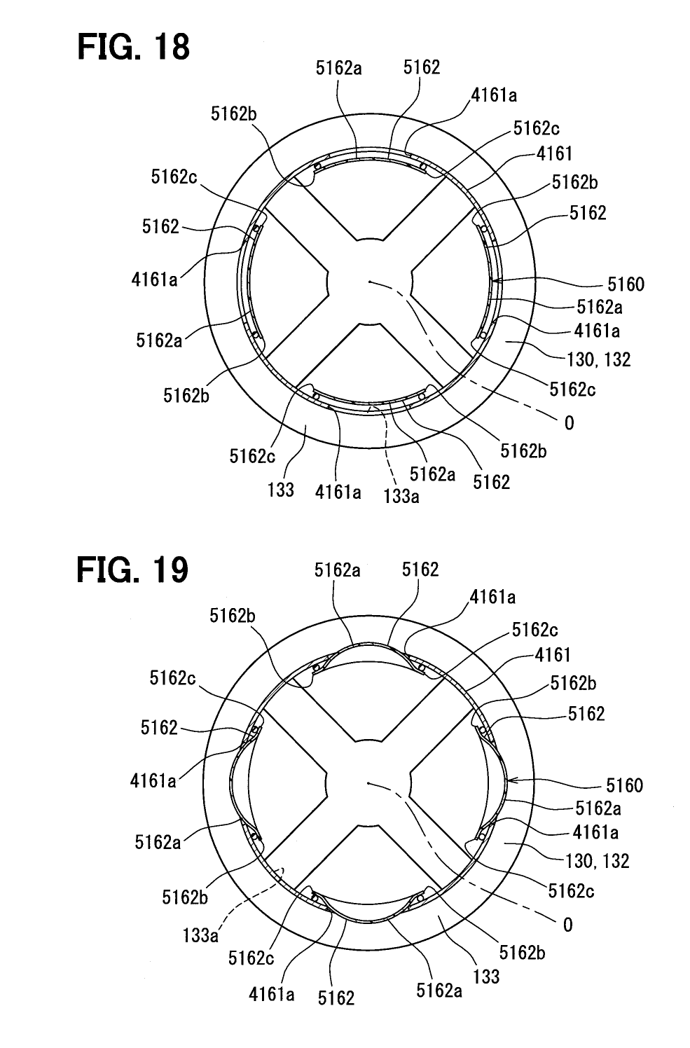

A fifth embodiment of the present disclosure, which is a modification of the fourth embodiment, will be described with reference to FIGS. 18 and 19. In the fifth embodiment, each of two partition structures 5160 includes a single primary partition member 4161 and a plurality of secondary partition members 5162. The primary partition member 4161 is similar to that of the fourth embodiment and thereby includes a plurality of through windows 4161a, which are arranged one after another in the circumferential direction and radially extend through the primary partition member 4161. Unlike the fourth embodiment, one circumferential end portion 5162b and the other circumferential end portion 5162c of each secondary partition member 5162 are held at two locations, respectively, which are circumferentially outwardly displaced from the corresponding through window 4161a, at the primary partition member 4161. Thereby, in the stop state of the rotatable brake body 130, each secondary partition member 5162, to which the centrifugal force F is not applied, is placed in the initial state of FIG. 18 by elastically (resiliently) contracting a circumferentially intermediate portion 5162a of the secondary partition member 5162, which is circumferentially placed between the one circumferential end portion 5162b and the other circumferential end portion 5162c, toward the rotational center O. In contrast, in the rotating state of the rotatable brake body 130, each secondary partition member 5162, to which the centrifugal force F is applied, is placed in the displaced state of FIG. 19 in the corresponding gap 117 through the elastic expansion of the circumferentially intermediate portion 5162a in the application direction of the centrifugal force F (in the radially outward direction). At this time, the circumferentially intermediate portion 5162a of each secondary partition member 5162 covers the corresponding through window 4161a, which is radially opposed to the secondary partition member 5162, so that one axial end portion and the other axial end portion of the secondary partition member 5162 contact the primary partition member 4161 around the through window 4161a. As a result, even in each corresponding location, at which the corresponding through window 4161a is formed, the radially outer region 117a and the radially inner region 117b are partitioned by the corresponding secondary partition member 5162.

In each partition structure 5160 of the fifth embodiment, the circumferentially intermediate portion 5162a of each secondary partition member 5162, which is held by the primary partition member 4161, is elastically expanded in the application direction of the centrifugal force F (in the radially outward direction) upon the application of the centrifugal force F from the rotating magnetic rotor 132 to the secondary partition member 5162, and thereby the corresponding through window 4161a is covered with the secondary partition member 5162. Therefore, the communication between the radially inner region 117b and the radially outer region 117a through each through window 4161a is limited. Thus, the reliable partitioned state, in which the radially inner region 117b and the radially outer region 117a are partitioned from each other, can be maintained through the cooperation of the primary partition member 4161 and the secondary partition members 5162. Furthermore, in the stop state of the rotatable brake body 130, the centrifugal force F is lost, and thereby the circumferentially intermediate portion 5162a of each secondary partition member 5162 is returned to the initial state to open the corresponding through window 4161a. As a result, the movement of the magneto-rheological particles 140a between the radially inner region 117b and the radially outer region 117a is enabled. Furthermore, the setting freedom of the size of each through window 4161a and the size of each secondary partition member 5162 is relatively high. Therefore, through the setting of the size of each through window 4161a and the size of each secondary partition member 5162, the amount of movement of the magneto-rheological particles 140a, which is required to limit the variation in the brake torque, can be appropriately adjusted. Therefore, even in the fifth embodiment, the advantages, which are similar to those of the fourth embodiment, can be achieved.

### Sixth Embodiment

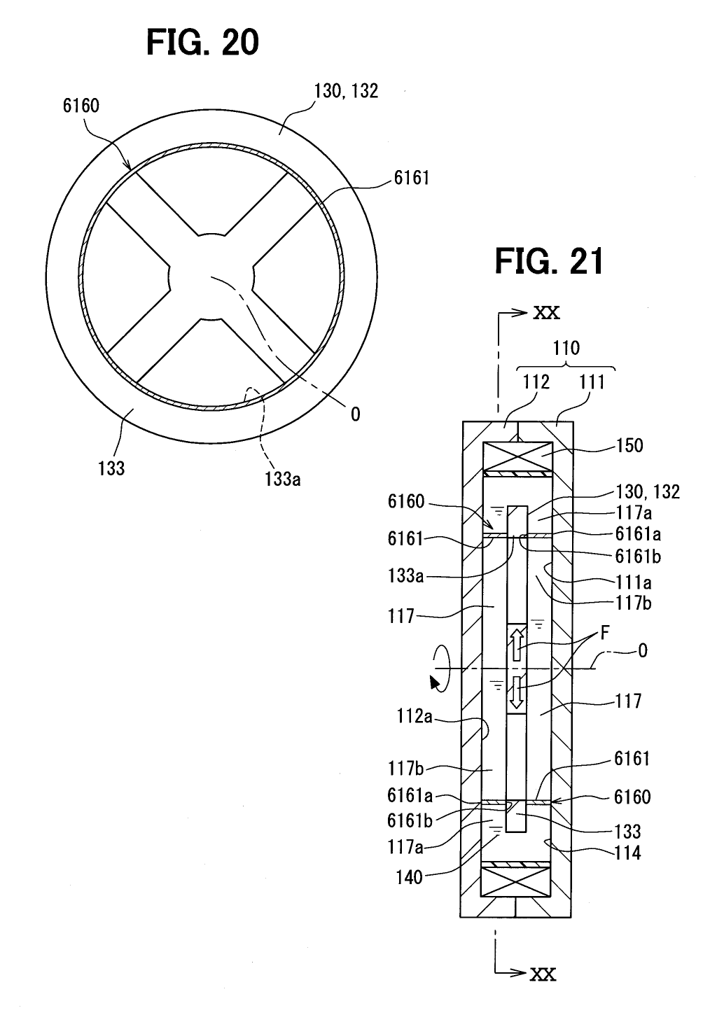

A sixth embodiment of the present disclosure, which is a modification of the first embodiment, will be described with reference to FIGS. 20 and 21. Each of two partition structures 6160 of the sixth embodiment includes a single partition member 6161, which is made of a metal material or a resin material and is configured into a cylindrical tubular body that has a rigid thin wall. One axial end portion 6161a of the partition member 6161 of one of the two partition structures 6160 is fixed to the inner surface 111a of the stationary member 111 to place the partition member 6161 in the gap 117 between the stationary member 1111 and the magnetic rotor 132. One axial end portion 6161a of the partition member 6161 of the other one of the partition structures 6160 is fixed to the inner surface 112a of the cover member 112 to place the partition member 6161 in the gap 117 between the cover member 112 and the magnetic rotor 132.

Here, the other axial end portion 6161b of each partition member 6161 is placed at a corresponding location, which is slightly spaced from or contacts the inner peripheral part 133a of the magnetic portion 133. In this way, each partition member 6161 of the present embodiment partitions between the radially outer region 117a and the radially inner region 117b in both of the stop state and the rotating state of the rotatable brake body 130.

According to the sixth embodiment discussed above, the single partition member 6161 of each partition structure 6160 partitions between the radially outer region 117a and the radially inner region 117b in the corresponding gap 117 of the fluid chamber 114 at least in the rotating state of the rotatable brake body 130. Therefore, according to the principle, which is similar to that of the first embodiment, the stable brake performance can be achieved.

Furthermore, the partitioned state, in which the radially inner region 117b and the radially outer region 117a are partitioned from each other in each gap 117, can be reliably maintained by the corresponding partition structure 6160 at the corresponding location between the housing 110 (more specifically the corresponding one of the stationary member 111 and the cover member 112) and the rotatable brake body 130 regardless of the operational state of the rotatable brake body 130 (regardless of whether the rotatable brake body 130 is in the stop state or the rotating state). In this way, the movement of the magneto-rheological particles 140a from the radially inner region 117b to the radially outer region 117a is limited, and thereby the variation in the brake torque, which is applied to the magnetic portion 133, can be limited. Thus, the stability of the braking performance can be improved.

Now, modifications of the above embodiments will be described.

The present disclosure has been described with reference to the above embodiments. However, the present disclosure is not limited to the above embodiments, and the above embodiments may be modified within the principle of the present disclosure.

Specifically, for instance, in each partition structure 160, 2160, 3160, 4160, 5160 of each of the first to fifth embodiments, each corresponding partition member 161, 2161, 3161, 4161, 4162, 5162 can be fixed to the corresponding one of the stationary member 111 and the cover member 112 of the housing 110 in a manner similar to that of the sixth embodiment. In such a case, the displacement of the corresponding portion of each corresponding partition member 161, 2161, 3161, 4162, 5162 can be achieved upon application of the centrifugal force F of the rotatable brake body 130 to it through the magneto-rheological fluid 140. Furthermore, the partition member 6161 of each partition structure 6160 of the sixth embodiment may be held by the inner peripheral part 133a of the magnetic portion 133 of the rotatable brake body 130 to enable the integral rotation of the partition member 6161 with the rotatable brake body 130 instead of holding the partition member 6161 of each partition structure 6160 by the housing 110. Furthermore, the present disclosure is also applicable to any other type of valve timing control apparatus, which controls valve timing of exhaust valves or which controls both of the valve timing of the intake valves and the valve timing of the exhaust valves, or is also applicable to various other types of apparatuses, which use the brake torque.

What is claimed is:

1. A fluid brake device comprising:
a housing that forms a fluid chamber in an inside of the housing;
a magneto-rheological fluid that includes a plurality of magneto-rheological particles dispersed in the magneto-rheological fluid and is filled in the fluid chamber, wherein a viscosity of the magneto-rheological fluid changes in response to a magnetic flux that passes through the magneto-rheological fluid;
a viscosity control device that variably controls the viscosity of the magneto-rheological fluid by generating the magnetic flux that passes through the magneto-rheological fluid in the fluid chamber;
a rotatable brake body that includes a magnetic portion, through which the magnetic flux generated by the viscosity control device passes, wherein a brake torque, which corresponds to the viscosity of the magneto-rheological fluid, is applied to the rotatable brake body during rotation of the rotatable brake body in a circumferential direction through contact of the magnetic portion with the magneto-rheological fluid in the fluid chamber; and
a partition structure that partitions the fluid chamber between a radially outer region, in which the magnetic portion is exposed, and a radially inner region, which is located on a radially inner side of the radially outer region in a radial direction of the rotatable brake body, during rotation of the rotatable brake body.

2. The fluid brake device according to claim 1, wherein:
the partition structure includes at least one partition member, which is placed in the fluid chamber in a location that is between the housing and the rotatable brake body in an axial direction of the rotatable brake body; and
the at least one partition member is rotatable integrally with the rotatable brake body in a state where the at least one partition member partitions between the radially outer region and the radially inner region.

3. The fluid brake device according to claim 2, wherein:
a radially outer portion of the at least one partition member is held by the rotatable brake body; and
the at least one partition member partitions between the radially outer region and the radially inner region when a radially inner portion of the at least one partition member is displaced in a radially outward direction upon application of a centrifugal force of the rotatable brake body to the at least one partition member.

4. The fluid brake device according to claim 3, wherein:
the at least one partition member includes an annular partition member;
the radially outer portion of the annular partition member is configured into an annular form and is held by the rotatable brake body along an entire circumferential extent of the rotatable brake body; and
the radially inner portion of the annular partition member is displaced in the radially outward direction upon elastic expansion of the annular partition member when the annular partition member receives the centrifugal force of the rotatable brake body.

5. The fluid brake device according to claim 3, wherein:
the at least one partition member of the partition structure includes a plurality of partition members, which are arranged one after another in the circumferential direction such that circumferential end portions of each circumferentially adjacent two of the plurality of partition members are circumferentially overlapped with each other; and
the radially inner portion of each of the plurality of partition members is swung about the radially outer portion in the radially outward direction when the partition member receives the centrifugal force of the rotatable brake body.

6. The fluid brake device according to claim 2, wherein the at least one partition member of the partition structure includes:
a primary partition member, which is held by the rotatable brake body and partitions between the radially outer region and the radially inner region, wherein the primary partition member forms at least one through window, which radially extends through the primary partition member; and
at least one secondary partition member that has one circumferential end portion, which is held by the primary partition member, and the other circumferential end portion that is circumferentially opposite from the one circumferential end portion, wherein the at least one secondary partition member covers the at least one through window of the primary partition member when the other circumferential end portion is swung about the one circumferential end portion in a radially outward direction upon application of a centrifugal force of the rotatable brake body to the at least one secondary partition member.

7. The fluid brake device according to claim 2, wherein the at least one partition member of the partition structure includes:
a primary partition member, which is held by the rotatable brake body and partitions between the radially outer region and the radially inner region, wherein the primary partition member forms at least one through window, which radially extends through the primary partition member; and
at least one secondary partition member that has two circumferential end portions, which are circumferentially opposite to each other and are held by the primary partition member, wherein the at least one secondary partition member covers the at least one through window of the primary partition member when an intermediate portion of the at least one secondary partition member, which is located between the two circumferential end portions of the at least one secondary partition member, is elastically expanded in a radially outward direction upon application of a centrifugal force of the rotatable brake body to the at least one secondary partition member.

8. The fluid brake device according to claim 1, wherein the at least one partition member of the partition structure includes a partition member, which is placed in the fluid chamber between the housing and the rotatable brake body in an axial direction of the rotatable brake body and is fixed to the housing in a state where the partition member partitions between the radially outer region and the radially inner region.

9. A valve timing control apparatus that adjusts valve timing of a valve, which is opened and is closed by a camshaft through transmission of a torque from a crankshaft at an internal combustion engine, wherein the valve timing control apparatus comprising:
the fluid brake device of claim 1; and
a phase adjusting mechanism that is connected to a rotatable shaft of the rotatable brake body at an outside of the housing and adjusts a relative phase between the crankshaft and the camshaft in response to the brake torque, which is inputted to the rotatable brake body of the fluid brake device.
